(19) United States
(12) Patent Application Publication
(10) Pub. No.: US 2025/0060548 A1
(43) Pub. Date: Feb. 20, 2025

(54) FLAME RETARDANT OPTICAL FIBER CABLE HAVING A FOAMED CABLE JACKET AND METHOD OF MAKING SAME

(71) Applicant: CORNING RESEARCH & DEVELOPMENT CORPORATION, Corning, NY (US)

(72) Inventors: Xiaole Cheng, Painted Post, NY (US); Jie Feng, Berlin (DE)

(21) Appl. No.: 18/938,512

(22) Filed: Nov. 6, 2024

Related U.S. Application Data
(63) Continuation of application No. PCT/US2023/023495, filed on May 25, 2023.
(60) Provisional application No. 63/347,622, filed on Jun. 1, 2022.

(51) Int. Cl. G02B 6/44; C08K 3/016

(52) U.S. Cl. CPC G02B 6/4436; G02B 6/4479; C08K 3/016

(57) ABSTRACT

Embodiments of a low-smoke, zero halogen (LSZH) composition for forming a foamed cable jacket are provided. The LSZH composition includes a polymer component, and an LSZH flame retardant package dispersed in the polymer component. The LSZH composition further includes a chemical foaming agent that is present in an amount up to 5% by weight of the LSZH composition and a melt strength enhancer that is present in an amount up to 1% by weight of the LSZH composition. Also provided are embodiments of an optical fiber cable having a cable jacket surrounding a cable core. The cable jacket is made from the LSZH composition, which has a first density. The cable jacket has a foamed region with a second density that is 50% to 95% of the first density.

### CROSS-REFERENCE TO RELATED APPLICATIONS

This application is a continuation of International Application No. PCT/US2023/023495, filed May 25, 2023, which claims the benefit of priority of U.S. Provisional Application Ser. No. 63/347,622 filed on Jun. 1, 2022, the content of which is relied upon and incorporated herein by reference in its entirety.

### BACKGROUND

The disclosure relates generally to flame retardant compositions and more particularly to a low-smoke, zero halogen flame retardant composition for forming foamed cable jackets and cables including same. Optical fiber cables typically have cable jackets made from a polymeric material. When used in certain applications, it may be desirable to use a flame retardant additives in the polymeric material of the cable jacket. Flame retardant cable jackets may help diminish the effects of a fire or prevent spread when a fire breaks out in a premises. For example, some flame retardants may limit the amount of smoke produced by the fire, and others may limit the ability of the fire to spread along the cable, thereby cutting off one pathway for a fire to spread to multiple rooms of a premises.

### SUMMARY

In one aspect, embodiments of the present disclosure relate to a low-smoke, zero halogen (LSZH) composition for forming a foamed cable jacket. The LSZH composition includes a polymer component, and an LSZH flame retardant package dispersed in the polymer component. The LSZH composition further includes a chemical foaming agent that is present in an amount up to 5% by weight of the LSZH composition and a melt strength enhancer that is present in an amount up to 1% by weight of the LSZH composition.

In another aspect, embodiments of the present disclosure relate to an optical fiber cable. The optical fiber cable includes a cable jacket having an inner surface and an outer surface. The inner surface defines a central bore extending along a length of the optical fiber cable. A cable core is disposed within the central bore, and the cable core includes at least one optical fiber. The cable jacket is made from an LSZH polymer composition having a first density. The cable jacket has a foamed region that extends at least a portion of the distance between the inner surface and the outer surface, and the foamed region has a second density that is 50% to 95% of the first density.

In still another aspect, embodiments of the present disclosure relate to a method of forming an optical fiber cable. In the method, a flame retardant polymer mixture is formed. The flame retarding polymer mixture includes a polymer component, an LSZH flame retardant package, and a melt strength enhancer. In the method, the flame retardant polymer mixture is extruded to form a cable jacket around a cable core having at least one optical fiber while entrapping gas bubbles within the cable jacket.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts an optical fiber cable having a jacket comprised at least partially of a foamed LSZH composition, according to an exemplary embodiment; and

FIG. 2 is a flow diagram of the steps of preparing an optical fiber cable having a foamed LSZH cable jacket, according to an exemplary embodiment.

### DETAILED DESCRIPTION

Referring generally to the figures, various embodiments of a low-smoke, zero halogen (LSZH) polymer composition for forming a foamed cable jacket, an optical fiber cable having a foamed LSZH cable jacket, and a method of forming the same are provided. The inventors have found that foaming the cable jacket does not diminish and may even improve the flame retardant performance of the cable jacket while decreasing the cost to produce the optical fiber cable and decreasing the weight of the optical fiber cable. Further, the foamed cable jacket is expected to improve the crush performance of the optical fiber cable. These and other aspects and embodiments of the disclosed LSZH polymer composition, foamed cable jacket, and method of forming the same will be described herein and in relation to the figures. Such exemplary embodiments are provided by way of illustration and not by way of limitation.

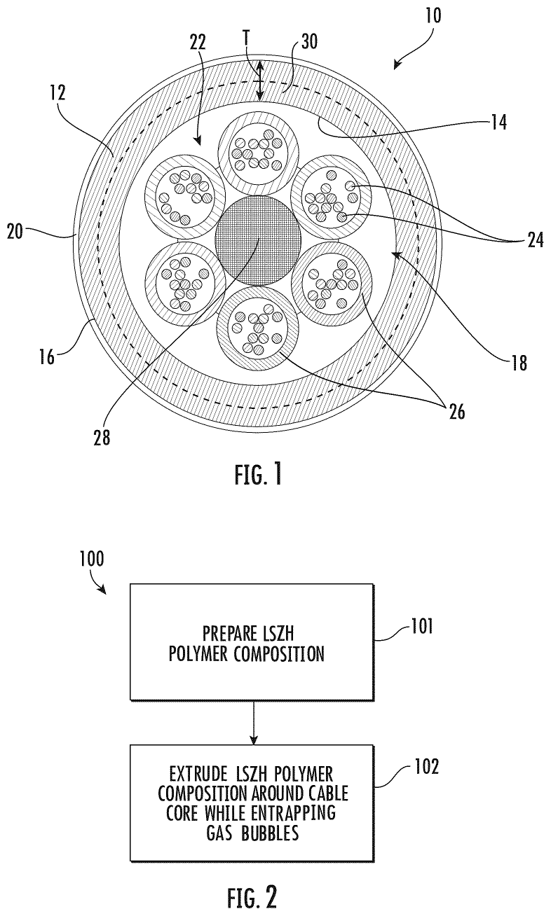

FIG. 1 depicts an exemplary embodiment of an optical fiber cable 10. The optical fiber cable 10 includes a cable jacket 12. The cable jacket 12 includes an inner surface 14 and an outer surface 16. The inner surface defines a central bore 18 of the optical fiber cable 10. In one or more embodiments, the outer surface 16 of the cable jacket 12 is an outermost surface of the optical fiber cable 10. In one or more other embodiments, the cable jacket 12 may be surrounded by a skin layer 20, which may be a thin layer extruded around the cable jacket 12, e.g., to reduce the coefficient of friction to promote sliding within a cable duct during blowing or pulling of the optical fiber cable 10.

Disposed within the central bore 18 is a cable core 22. The cable core 22 includes all of the elements within the cable jacket 12 including at least one optical fiber 24. In the embodiment depicted, the optical fibers 24 are contained in buffer tubes 26 stranded around a central strength member 28. In particular, FIG. 1 depicts six buffer tubes 26 stranded around and contacting the central strength member 28. Each buffer tube 26 in the embodiment depicted contains twelve optical fibers 24 in a loose tube configuration. The embodiment of the optical fiber cable 10 is merely illustrative.

In other embodiments, the cable core 22 can include anywhere from one to several hundred or even thousands of optical fibers 24. Further, the optical fibers 24 may be in a loose tube or ribbon configuration within the buffer tubes 26. Additionally, the optical fibers 24 may not be arranged in buffer tubes 26 and may instead be loose within the cable jacket 12 or arranged in ribbons within the cable jacket 12. Still further, the optical fibers 24 may be divided into other subunit structures, such as grouped within binding films or thin membranes. In one or more embodiments, the cable core 22 includes one or more other structures, such as an armor layer; a water-blocking tape, powder, or yarn; strengthening yarns; a binder wrap or film; and a ripcord, among other possibilities.

According to embodiments of the present disclosure, the cable jacket 12 comprises a flame retardant composition and is at least partially foamed. The cable jacket 12 has a thickness T between the inner surface 14 and the outer surface 16. In one or more embodiments, the thickness T is from 0.5 mm to 5 mm, in particular from 0.5 mm to 3 mm. In one or more embodiments, the cable jacket 12 includes a foamed region 30 that comprises at least 30% of the thickness T, at least 50% of the thickness T, or at least 80% of the thickness T. In one or more embodiments, the foamed region 30 starts at the inner surface 14 and extends toward the outer surface 16, and in one or more other embodiments, the foamed region 30 starts at the outer surface 16 and extends toward the inner surface 14. In still one or more embodiments, the foamed region 30 is intermediate of the inner surface 14 and the outer surface 16. In one or more embodiments, the positioning of the foam region 30 can be controlled by extruding foaming and nonfoaming flame retardant composition in different layers.

In one or more embodiments, the flame retardant composition of the cable jacket 12 is a low-smoke, zero halogen (LSZH) composition. Such compositions do not produce large amounts of smoke when combusted and are formed from polymers that do not contain halogen groups (e.g., chlorine and fluorine) or that do not include halogenated additives or modifiers (e.g., brominated flame retardants). In one or more embodiments, the LSZH composition is a highly filled composition that comprises a flame retardant package with, e.g., 40% to 80% by weight of a flame retardant additive, such as alumina trihydrate (ATH), magnesium dihydroxide (MDH), or zinc borates, among other synergists. The remainder of the composition is comprised of at least a polymer component and may also contain various additives, such as antioxidants, UV stabilizers, and colorants, among other processing and performance aids.

In one or more embodiments, the LSZH composition includes an intumescent package having a carbon source, an acid source, optionally a synergist, and optionally a spumific compound. An example of such an LSZH flame retardant package includes pentaerythritol (PER) as a carbon source; ammonium polyphosphate (APP) as an acid source; a zeolite, a clay, a bentonite, and/or zinc borate as a synergist; and melamine as a spumific compound. In general, such LSZH compositions contain a lower fill level of the intumescent package than a highly-filled LSZH composition, such as the intumescent package in a range from about 15% to about 35% by weight of the LSZH composition.

In one or more embodiments, the polymer component of the LSZH composition includes one or more thermoplastic polymers, elastomers, thermoplastic elastomers, or a combination thereof. Exemplary polymers include ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the foregoing polymers listed above. Other polymers are possible for use in the polymer component of the LSZH composition, and the foregoing list is merely illustrative. In one or more embodiments, the polymer component comprises from 10% to 85% by weight of the LSZH composition, in particular 20% to 75% by weight of the LSZH composition.

In one or more embodiments, the cable jacket 12 can be formed by physical foaming or chemical foaming. During physical foaming, high pressured gas is injected into the molten LSZH composition as it is being extruded to form the cable jacket 12. In one or more embodiments, the gas used during physical foaming is an inert gas, such as nitrogen, and carbon dioxide, or is a hydrocarbon gas, such as butane and pentane. During chemical foaming, a foaming agent is included in the LSZH composition that decomposes during extrusion to produce gas within the molten LSZH composition. In either the physical foaming or the chemical foaming case, the gas is trapped within the LSZH composition, leaving behind gas bubbles within the cable jacket 12. Advantageously, gases trapped in the gas bubbles may be released during combustion of the optical fiber cable 10, which dilutes the oxygen in the vicinity of the optical fiber cable 10, slowing down flame propagation and improving burn performance.

In one or more embodiments, the LSZH composition comprises a chemical foaming agent and a melt strength enhancer. In one or more embodiments, the chemical foaming agent is an exothermic chemical foaming agent, and in one or more other embodiments, the chemical foaming agent is an endothermic foaming agent. In one or more embodiments, a combination of exothermic and endothermic foaming agents is used. Examples of exothermic foaming agents include azodicarbonamide, oxy-bis-benzenesulfonylhydrazide, toluenesulfonylhydrazide, benzenesulfonylhydrazide, toluenesulfonylsemicarbazide, 5-phenyltetrazole, dinitrosopentamethylenetetramine, hydrazocarbonamide, azobisisobutyronitrile, barium azodicarboxylate, and combinations thereof, and examples of endothermic chemical foaming agents include citric acid, sodium bicarbonate, ammonium carbonate, ammonium bicarbonate, calcium azide, and combinations thereof. In one or more embodiments, the melt strength enhancer is a peroxide masterbatch. Examples of suitable peroxide masterbatches used as a melt strength enhancer include but are not limited to 5% to 20% by weight dicumyl peroxide or di(tert-butylperoxyisopropyl)benzene masterbatches.

In one or more embodiments, the LSZH composition includes 5% by weight or less of the chemical foaming agent, in particular 3% by weight or less, and most particularly 1% by weight or less. In one or more embodiments, the LSZH composition includes at least 0.1% by weight of the chemical foaming agent. In one or more embodiments, the LSZH composition includes 1% by weight or less of the melt strength enhancer, in particular 0.8% by weight or less, and most particularly 0.5% by weight or less. In one or more embodiments, the LSZH composition includes at least 0.1% by weight of the melt strength enhancer. In one or more embodiments, the LSZH composition may also include up to 5% by weight of other processing or performance aids, such as antioxidants, colorants, slip agents, and stabilizers, among others.

In one or more embodiments, the foamed LSZH composition has density reduction of no more than 50%. That is, the density of the foamed LSZH composition is at least 50% of the unfoamed, fully dense LSZH composition. In one or more embodiments, the foamed LSZH composition has a density reduction of no more than 40%, and in still one or more further embodiments, the LSZH composition has a density reduction of no more than 30%.

In one or more embodiments, the gas bubbles have a maximum cross-sectional dimension of up to 100 μm, up to 200 μm, up to 300 μm, up to 400 μm, or up to 500 μm. In one or more embodiments, the gas bubbles have a maximum cross-sectional dimension of at least 10 μm. In one or more embodiments, the gas bubbles are uniformly distributed within the foamed region of the cable jacket 12. In one or more embodiments, the foam has a closed cell morphology.

Having described an embodiment of the optical fiber cable 10 and an LSZH composition for the cable jacket 12 thereof, an embodiment of a method 100 of extruding the cable jacket 12 around the cable core 22 is now described in relation to the embodiment depicted in FIG. 1 and the flow diagram of FIG. 2. In one or more embodiments, the method 100 involves a first step 101 of preparing the LSZH composition by mixing a polymer component, an LSZH flame retardant package, optionally a chemical foaming agent, and preferably a melt strength enhancer. The chemical foaming agent is optional depending on whether the LSZH flame retardant package is physically foamed or chemically foamed. In one or more embodiments, the melt strength enhancer may be preferable to maintain the mechanical properties of the foamed composition and to reduce the peak heat release rate as will be discussed more fully below.

After the first step 101, the LSZH composition is extruded around a cable core 22 in a second step 102. During the extruding step 102, the LSZH composition is foamed either by injecting a gas into the LSZH composition to physically foam the LSZH composition. Alternatively, during the extrusion step 102, the LSZH composition is foamed by decomposition of the chemical foaming agent included in the LSZH composition. In particular, the elevated temperature and mixing in the extrusion barrel of the extruder causes the chemical foaming agent to decompose to produce gases that are trapped as bubbles within the LSZH composition upon solidification. Depending on whether the foamed region 30 comprises the entire thickness of the cable jacket 12 or only just a portion thereof, the LSZH composition may be extruded in one or more layers to form the cable jacket 12.

Table 1, below, provides a comparison of the mechanical and flame retardant properties of two highly filled LSZH compositions and foamed versions thereof. The first highly filled LSZH composition, Comparative Example 1 (“CE1”), is based on a polymer component of polyethylene and contains about 60% by weight of a flame retardant filler. The second highly-filled LSZH composition, Comparative Example 2 (“CE2”), is based on a polymer component of thermoplastic olefin elastomer and contains more than 70% by weigh of a flame retardant filler. In certain applications, the composition of Comparative Example 2 can be considered a bedding compound, which is so highly filled that the mechanical properties of the polymer component of composition are almost negligible. Examples 1 and 2 (“E1” and “E2”) were foamed versions of Comparative Example 1, and Examples 3 and 4 (“E3” and “E4”) were foamed versions of Comparative Example 2. Example 1 contained 2 wt % of an endothermic foaming agent, and Example 2 contained 1 wt % of the endothermic foaming agent and 0.5 wt % of a peroxide masterbatch melt strength enhancer. Example 3 contained 1 wt % of an exothermic foaming agent, and Example 4 contained 1 wt % of the endothermic foaming agent.

The properties listed in Table 1 include density of the samples, density reduction, limiting oxygen index (LOI), total heat release (THR), peak heat release rate (PHRR), tensile strength, and elongation at break. The density was measured using the buoyancy method, and density reduction was calculated as ((1−density_{foamed}/density_{unfoamed})×100). THR and PHRR were measured using cone calorimetry. The THR measurement was based on the samples of the same volume. Tensile strength and elongation at break were measured according to ASTM D638 at a strain rate of 50 mm/min.

TABLE 1
Properties of Highly-Filled LSZH Compositions and Foams formed therefrom

| | | Density | | | | Tensile | Elongation |
|---|---|---|---|---|---|---|---|
| | Density | Reduction | LOI | THR | PHRR | Strength | at Break |
| Samples | (g/cm³) | (%) | (%) | (MJ/m²)* | (kW/m²) | (MPa) | (%) |
| CE1 | 1.54 | N/A | 38 | 60.4 | 211.5 | 10.2 | 183.7 |
| CE2 | 1.70 | N/A | 59 | 23.7 | 183.7 | N/A | N/A |
| E1 | 1.04 | 32 | 45 | 41.1 | 263.0 | 6.3 | 57.8 |
| E2 | 1.14 | 26 | 42 | 45.3 | 210.2 | 8.1 | 97.6 |
| E3 | 1.37 | 19 | 56 | 20.8 | 193.4 | N/A | N/A |
| E4 | 1.38 | 19 | 56 | 20.8 | 201.5 | N/A | N/A |

From Table 1, it can be seen that Example 1 had a density reduction of about 32.5% relative to Comparative Example 1 (decreased from 1.54 g/cm³ to 1.04 g/cm³). Notwithstanding the foaming, Example 1 exhibited an improved limiting oxygen index (LOI), going from 38% to 45%. Further, the total heat release (THR) decreased from 60.4 MJ/m² to 41.1 MJ/m²; although, the peak heat release rate (PHRR) increased from 211.5 kW/m² to 263.0 kW/m². In terms of mechanical properties, the tensile strength and elongation at break of Example 1 were reduced from Comparative Example 1; however, these properties are not of significant concern to the performance of a cable jacket of an optical fiber cable. Example 2, which included less foaming agent, had a density reduction of about 26% (decreased from 1.54 g/cm³ to 1.14 g/cm³). At 42%, the LOI was less than Example 1 but still improved from Comparative Example 1. Similarly, the THR of 45.3 MJ/m² was slightly higher than the THR of Example 1 but still well below the THR of Comparative Example 1. Advantageously, the PHRR of 210.2 kW/m² was lower than both Example 1 and Comparative Example 1. Further, the mechanical properties of tensile strength and elongation at break were improved from Example 1, though still below those of Comparative Example 1. The improvement in mechanical properties in Example 2 as compared to Example 1 is believed to be the result of the inclusion of the melt strength enhancer, which created cross-linking in the polymer component of the LSZH composition.

With respect to Comparative Example 2 and Examples 3 and 4, it can be seen that both the exothermic and the endothermic foaming agents were effective at reducing the density of the LSZH composition by about 19% (decreased from 1.70 g/cm³ to about 1.38 g/cm³). Comparative Example 2 maintained a higher LOI at about 59%, but the LOI was only reduced to 56% by foaming in Examples 3 and 4. THR for Examples 3 and 4 was lower than for Comparative Example 2 (20.8 MJ/m² vs. 23.7 MJ/m²). While PHRR was higher for Examples 3 and 4 than for Comparative Example 2, it was not significantly higher (193.4 kW/m² for Example 3, 201.5 kW/m² for Example 4, and 183.7 kW/m² for Comparative Example 2). As mentioned above, the mechanical properties of Comparative Example 2 are negligible because of the amount of filler material, and thus, the mechanical properties were not tested. Despite the low mechanical properties of Examples 3 and 4, the highly filled LSZH bedding compound can be used as an inner foam region 30 of a cable jacket 12.

Based on Table 1, the inventors surmise that the decrease in THR relates to the lower mass per volume of the foamed samples. That is, for a cable jacket 12 of a given size (i.e., thickness and length), a foamed cable jacket 12 would have less combustible material than a fully dense cable jacket 12. Also from Table 1, the inventors surmise that the increase in PHRR for some of the samples may be related to non-uniform morphology of the gas bubbles in the foam, and the inventors expect that PHRR will improve with improved uniformity in dispersion of the gas bubbles. For Example 2, which exhibited a decrease in PHRR, the inventors believe that the decrease was the result of the small size of the gas bubbles, which helps to stabilize the charring layer during burning. The foam morphology was controlled in part by the use of the melt strength enhancer in Example 2.

As mentioned, the mechanical properties of tensile strength and elongation at break are not the most relevant parameters related to the performance of the cable jacket 12. One important parameter related to the performance of the cable jacket 12 is the crush performance. Specifically, it is desirable that the cable jacket 12 protect the optical fibers 24 against attenuation when the optical fiber cable 10 experiences a crushing force. In particular, attenuation is desirably maintained below 0.15 dB at a crush force of up to 2000 N. It is expected that the foaming of the cable jacket 12 will cushion the cable core 22 against crush forces, increasing the crush force required to cause 0.15 dB of attenuation. Similar improvements to attenuation losses are expected for the related properties of flex and twist of the optical fiber cable 10.

Further, the inventors expect flame spread as measured according to EN 50399 of an optical fiber cable 10 with a foamed cable jacket 12 to be improved over an optical fiber cable with a solid, fully dense cable jacket. In particular, as mentioned above, the entrapment of the inert gases in the cable jacket 12 are expected to dilute oxygen in the atmosphere around the burning cable, slowing combustion and therefore flame propagation. Further, from tests of the foamed LSZH composition extruded around a central strength element, it is expected that flame spread is expected to improve with increasing density reduction (e.g., a cable jacket 12 with 15% density reduction is expected to reduce flame spread more so than a cable jacket 12 with 10% density reduction).

According to embodiments of the present disclosure, an LSZH composition for forming a foamed cable jacket 12, an optical fiber cable 10 having a foamed cable jacket 12, and a method of forming same are provided. Surprisingly and unexpectedly, the foamed cable jacket 12 has at least the same or improved flame retardant performance as compared to a solid, fully dense cable jacket. In particular, it was expected that the increase in surface area available to burn because of the foam morphology would diminish the flame retardant performance. Nevertheless, the inventors found that the foamed LSZH composition had a lower THR as a result of decreasing the total amount of combustible material. Further, by control of the foam morphology and uniformity, in particular using a melt strength enhancer, the inventors found that PHRR can also be reduced. Advantageously, by foaming the cable jacket 12, the amount of material used for the cable jacket 12 is reduced, reducing the cost of material inputs of the cable and also reducing the weight of the cable. Additionally, while certain mechanical properties of the cable jacket 12 are diminished, the important parameters of resistance to attenuation during crush, flex, and twist are improved.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an inner surface and an outer surface, the inner surface defining a central bore extending along a length of the optical fiber cable;
a cable core disposed within the central bore, the cable core comprising at least one optical fiber;
wherein the cable jacket comprises a low-smoke, zero-halogen (LSZH) polymer composition;
wherein the cable jacket comprises a first region that has a first density;
wherein the cable jacket comprises a second foamed region that extends a portion of a distance between the inner surface and the outer surface; and
wherein the foamed region comprises a second density that is 50% to 95% of the first density.

2. The optical fiber cable of claim 1, wherein the foamed region comprises a plurality of gas bubbles having a maximum cross-sectional dimension of 10 μm to 500 μm.

3. The optical fiber cable of claim 2, wherein the gas bubbles are filled with N₂ or CO₂.

4. The optical fiber cable of claim 1, wherein the foamed region extends from the inner surface of the cable jacket toward the outer surface for a radial distance up to 50% of a thickness between the inner surface and the outer surface.

5. The optical fiber cable of claim 1, wherein the LSZH polymer composition comprises at least 40% by weight of at least one of a flame retardant oxide, a hydroxide, or a hydrate.

6. The optical fiber cable of claim 5, wherein the flame retardant oxide, hydroxide, or hydrate comprises aluminum trihydrate, magnesium dihydroxide, or a zinc borate.

7. The optical fiber cable of claim 1, wherein the LSZH polymer composition comprises an intumescent system comprising an acid source, a carbon source, and a synergist.

8. The optical fiber cable of claim 1, wherein the LSZH composition comprises:
a polymer component;
an LSZH flame retardant package dispersed in the polymer component; and
a melt strength enhancer, the melt strength enhancer being present in an amount up to 1% by weight of the LSZH composition.

9. The optical fiber cable of claim 8, wherein the LSZH flame retardant package is an intumescent system comprising an acid source, a carbon source, and a synergist.

10. The optical fiber cable of claim 9, comprising from 15% to 35% by weight of the intumescent system.

11. The optical fiber cable of claim 8, wherein the LSZH composition further comprises a chemical foaming agent.

12. The optical fiber cable of claim 11, wherein the chemical foaming agent comprises at least one of azodicarbonamide, oxy-bis-benzenesulfonylhydrazide, toluenesulfonylhydrazide, benzenesulfonylhydrazide, toluenesulfonylsemicarbazide, 5-phenyltetrazole, dinitrosopentamethylenetetramine, hydrazocarbonamide, azobisisobutyronitrile, or barium azodicarboxylate.

13. The optical fiber cable of claim 11, wherein the chemical foaming agent comprises at least one of sodium bicarbonate, ammonium carbonate, ammonium bicarbonate, and calcium azide, or citric acid.

14. The optical fiber cable of claim 8, wherein the melt strength enhancer comprises a peroxide masterbatch.

15. A method of forming an optical fiber cable, comprising:
preparing a flame retardant polymer mixture comprising a polymer component, a low smoke, zero halogen flame retardant package, and a melt strength enhancer; and
extruding the flame retardant polymer mixture to form a cable jacket around a cable core comprising at least one optical fiber while entrapping gas bubbles within the cable jacket such that the cable jacket comprises:
a first region that has a first density; and
a foamed second region that has a second density that is 50% to 95% of the first density.

16. The method of claim 15, wherein, during extruding, a gas is injected into the flame retardant polymer mixture to entrap the gas bubbles within the cable jacket.

17. The method of claim 16, wherein the gas comprises at least one of N₂, CO₂, butane, or pentane.

18. The method of claim 15, wherein the flame retardant polymer mixture further comprises a chemical foaming agent and wherein, during extruding, the chemical foaming agent decomposes to form the gas bubbles entrapped within the cable jacket.

19. The method of claim 18, wherein the chemical foaming agent comprises at least one of azodicarbonamide, oxy-bis-benzenesulfonylhydrazide, toluenesulfonylhydrazide, benzenesulfonylhydrazide, toluenesulfonylsemicarbazide, 5-phenyltetrazole, dinitrosopentamethylenetetramine, hydrazocarbonamide, azobisisobutyronitrile, barium azodicarboxylate, sodium bicarbonate, ammonium carbonate, ammonium bicarbonate, and calcium azide, or citric acid.

20. The method of claim 15, wherein the gas bubbles have a maximum cross-sectional dimension of 10 μm to 500 μm.
